(19) United States
(12) Patent Application Publication
(10) Pub. No.: US 2009/0173146 A1
(43) Pub. Date: Jul. 9, 2009

(54) Temperature programmed low thermal mass fast liquid chromatography analysis system

(76) Inventors: Matthias Pursch, Rheinmuenster (DE); Patric Eckerle, Rheinau (DE); Jim Luong, Sherwood Park (CA); Hernan Cortes, Midland, MI (US); Ronda Gras, Edmonton (CA); Kevin Hool, Midland, MI (US); Robert Mustacich, Santa Barbara, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/007,067

(22) Filed: Jan. 7, 2008

(51) Int. Cl. G01N 30/02

(52) U.S. Cl. 73/61.52

(57) ABSTRACT

A temperature programmed low thermal mass fast liquid chromatography system capable of high throughput and low power consumption includes a straight or curved short reloadable low-mass tubular heater with a capillary column extending inside. If the capillary column is long enough, it is coiled to form a coiled capillary LC column (the length of which does not exceed 0.2 m-1.0 m) packed in a singular module package with a heating wire and a temperature sensing wire extending along and in proximity to the LC capillary column. A tubular heater, e.g. a steel tubing, incorporates the LC capillary column, along with the heating wire and the temperatures sensor and is coiled to form a miniature power saving LC module which may be attached outside a chromatography oven. Capillary lengths extend inside the oven between the inlet and outlet of the LC column module and mobile phase source and detector, respectively. An electronic temperature control block is positioned outside the oven cavity and controls the heating of the capillary LC column, as well as other heated zones in the system.

### FIELD OF THE INVENTION

The present invention relates to liquid chromatography (LC) systems for analysis of chemical samples. In particular, the subject invention is directed to liquid chromatography analysis systems capable of high speed heating and cooling for the accelerated detection of compounds in a chemical sample and their analysis enhanced by the application of programmed temperature profiles to LC columns.

Moreover, the present system relates to liquid chromatographic column modules for temperature programmed analysis which may be removably integrated with a chromatography oven external to the oven cavity for efficient liquid chromatography analysis.

The present invention is also related to a miniature modular liquid chromatography system which includes a short capillary liquid chromatography column replaceably received within a stainless steel tube along with temperature sensing and heating mechanisms, which altogether are straight, or coiled to form a looped assembly if the capillary is of sufficient length, to optimize thermal effect and produce an overall low power consumption LC system.

The present invention further relates to liquid chromatography systems for conducting chromatographic analysis at high temperatures and particularly, to the liquid chromatography systems where fast temperature ramps are applied in a controlled fashion to optimize the process of the LC analysis.

### BACKGROUND OF THE INVENTION

Chromatography is a method for separating mixtures and identifying their components using the differences in partitioning behavior of analytes between a mobile phase and a stationary phase to separate components in a mixture. Components of a mixture may be interacting with a stationary phase based on charge, Van der Waals' forces, relative solubility, adsorption, etc. Liquid chromatography is a separation technique in which the mobile phase is a liquid. In the LC technique, the sample is forced through a column that is packed with particles or a porous monolithic layer (stationary phase) by a liquid (mobile phase) at a high pressure.

Liquid chromatography (LC) has become one of the most important separation technologies of the last two decades due to the increased applications of chromatography in condensed phases in areas such as pharmaceutics and biotechnology. The pursuit of technology improvements to achieve high throughput analysis for increasing laboratory productivity in liquid chromatography techniques have been focused in the areas of high pressure pumping systems, introduction of instruments capable of higher temperature operation, and reducing the particle sizes serving as stationary phases in LC columns.

LC analysis times are a function of flow rate, column length, mobile phase composition and temperature. To enhance the flow rates, pumps capable of higher pumping pressures with minimal variation in flow rates have enabled fast LC. For example, binary pumps that produce flow rates up to 5 ml/min at 600 bar have become a standard feature in Rapid Resolution LC instruments such as the “Agilent 1200” series. Such pumping systems provide high flow rates with sub-2-micron column technology to achieve high efficiency at elevated flow rates. Other high pressure instrumentation, such as the “Waters UPLC” series or “Therma Accela” series instruments, allow pressure operation at up to 1,000 Bar though at rates smaller than 5 ml/min.

Back pressure encountered by a pump forcing the liquid through the column, as well as the achievable flow rate, are directly dependent on the viscosity of the mobile liquid phase as well as the particle size of the stationary phase contained in LC columns. Since the viscosity of liquids decreases significantly with temperature increase, operation of LC at elevated temperatures may be desirable to increase flow rates, reduce back pressure, and permit the use of smaller particle columns for higher resolution. In addition, increased temperature may also result in increased diffusion rates in both mobile and stationary phases for improved efficiency and resolution of the LC system. An additional benefit of the increased temperature is the solvation and selectivity changes for solutes in the mobile phase resulting in reduced organic solvent consumption, hazards, and waste disposal.

The development of reduced particle size LC systems has progressed steadily from 5 μm particle sizes down to below 2 μm particle sizes. Although small particle sizes offer increased resolution in the LC system, they unfortunately can lead to significantly higher column back pressures, thus increasing demand on the performance of the pumping systems. In order to reduce the back pressure, the particle size distributions may be designed in addition to using elevated temperature to reduce the liquid viscosity.

Despite benefits associated with operating the LC systems at higher temperatures, the elevated temperature may introduce constraints that may be counter productive. An important problem is directed to the thermal stability of the column packing chemistry against highly aqueous or buffer containing mobile phases. New particle compositions and stationary phases have been under continuous development to improve stability at elevated temperatures. Precise temperature control and the generation of thermal gradients in the LC column bed are additional issues at higher temperature operation. Due to increased flow in the center of the packed bed compared to the walls, the entry into the mobile phase at a different temperature may produce non-uniform temperature distributions across the column bed and reduce resolution. Due to this “thermal-mismatch” effect, e.g., delay in the heat transfer from the walls to the center of a liquid undergoing laminar flow in a standard LC column (typically 4.6 mm wide), it has become a standard practice to pre-heat the mobile phase before it reaches the analytical column.

Despite the constraints associated with higher temperature operation, application of temperature gradients or temperature programming if applied to LC, has been found to provide a number of beneficial effects. These benefits include a large reduction in elution times for compounds which elute faster under lower viscosity conditions. As a consequence, such eluting compounds may also elute as narrower peaks with improved detection limits. Additional benefit may be the ability to rapidly elute a wide range of analytes in a short time. Additionally, fast temperature gradients are a powerful expedient for comprehensive two-dimensional LC (LC×LC) operation.

While temperature programming is common in gas chromatography (GC), there are many reasons why approaches that have been used in fast GC have not been employed in fast LC. One important reason is the gross disparity between LC columns and GC columns. The intrinsic features of low thermal mass gas chromatography (LTMGC) by packing many coils together to minimize surface area to save power and maximize heat exchange are reduced or absent in LC which uses extremely short column lengths.

LC column practice has been optimized to use short and relatively wide metal tubes that are packed with particles and are capable of handling high pressures. The column configuration currently most often recommended for analytical method development for LC is a column with the internal diameter of 4.6-mm and the length of 150-250 μm with a standard particle size of 5 μm. This is a thick-wall steel column having an outer diameter of 0.25 inch with large steel fittings for ¼-inch tubing at each end of the column.

This large LC column is in contrast to the lengthy fused silica capillaries commonly used for GC, which are usually 15-30 m in length and with inner diameters no larger than 0.32 mm. Short and wide steel columns for LC differ from very long, fine capillaries for GC. These are very different not only in design and dimensional parameters, but also in terms of their thermal compliance, or ability to transfer heat. The steel columns associated with narrow bore LC columns exaggerate the problem by moving the fluid in the center of a tube at a much faster velocity, thus reducing the effective residence time of the fluid at the central portion thereby undermining the ability to transfer heat.

The literal temperature programming of LC columns is a relatively recent practice compared to a widely used approach erroneously considered an analog of temperature programming in LC, which uses elution gradients (a changing blend of two different solvents which gradually changes the solvation properties of the mobile phase in a very rough analogy to changing the temperature), which has been and remains the standard practice in LC. The concept of elution gradients instead of temperature programming is still considered by most practitioners to be applicable in LC. Where implemented, the approaches in LC considered for temperature programming appear to be constrained by the conventional LC practice.

While the advantages of capillary and nano-LC columns are known, chromatographers have not utilized these columns for three reasons:

(a) applications taking full advantage of these advanced development have not been encountered yet,

(b) products on the market did not meet the expected performance, and

(c) available instrumentation did not provide the performance, sensitivity, reliability, or minimal band dispersion required for optimal results.

The establishment of 4.6 mm as a standard LC column inner diameter occurred in the 1970's since this size of stainless steel tube was compatible with the ¼-in. fittings used with packed column gas chromatography columns. It provided a safety factor for high pressure operation, and the larger internal diameter accommodated the evolving high pressure pumping technology required for LC. Presently, LC columns with inner diameters (i.d.) of 1.0-, 2.1- and 3-mm are also used but in limited applications. According to R.E. Majors, “the newer shorter columns (less than 50 mm) with 2.1- and 4.6-mm internal diameters packed with sub-2 micron media, although generating interest in the chromatography community, are still a small fraction of current columns in popular use,” (R.E. Majors, LCGC North America, August 2006, pp. 742-753). “Rapid Resolution liquid chromatography” (RRLC, Agilent Technologies, Palo Alto, Calif.), ultrahigh pressure liquid chromatography (U-HPLC), and ultrafast LC (UFLC) are considered to designate LC applications employing sub-2-micron media-containing columns with 1.0-4.6 mm i.d. (Frank et al., Am. Lab., March 2006, pp. 17-22).

Current state of the art in temperature programmed LC is based on LC column technology which has become standard in the industry, specifically the metal tubings in the range of 1.0-mm to more typically 4.6-mm i.d. LC column temperature is controlled by its placement within a temperature-controlled oven using forced air convection to distribute the heating. A capillary or nano LC column, if used in a specialized application for low flows such as LC/mass spectrometry, is accommodated in the same thermostat-controlled oven compartment as a standard column. Such an oven compartment is large, and the analysis cycle time, when temperature programmed, can become rate-limited by the speed with which the oven can be heated and cooled. The size of the instrumentation and the power consumption is also increased due to the relatively large oven compartment. The maximum heating rates used are 30° C./min for temperatures up to 130° C. and 20° C./min for temperatures up to 200° C. Cooling rates are in the range from 200° C. to 50° C. during 4 minutes.

There is a long-lasting need in the chromatographic community to achieve higher analysis throughput to meet LC analytical requirements. The minimum analysis cycle time consists of two components: (a) the time required for the analysis and (b) the time to prepare the instrument for the next analysis. While temperature programming of the LC column shortens the analysis time, the time to cool and re-establish the column and mobile phase temperatures back to the starting conditions adds time to the analysis. When conventional LC columns are used, the rates of heat transfer to the LC column are slow and the equilibration times are extensive. Operating continuously at an elevated temperature (to eliminate a cooling requirement between analyses cycles) provides an option for many applications, but the opportunities for applying temperature gradients for additional selectivity tuning are lost.

An energy efficient and fast temperature controlled LC analysis system in which the heat could be transferred to or from the LC column in an accelerated fashion is needed.

### SUMMARY OF THE INVENTION

It is an object of the present system to provide a liquid chromatography (LC) temperature programmed analysis capable of high analysis throughput.

It is a further object of the present concept to provide a temperature programmed LC analysis system capable of obtaining high heating and cooling rates due to capillary dimensions of LC column and modular miniature low thermal mass column concept.

It is another object of the present system to provide a fast temperature programmed low thermal mass LC analysis technique which achieves fast, temperature programming rates with low power consumption due to an innovative assembly of a capillary liquid chromatography column member with a temperature sensor and heater wires and a coiling the entire assembly to increase the internal contact of such components within a coiled section thus optimizing the heat exchange between the capillary LC column and other miniature components of the system for rapid exchange of heat therebetween to achieve fast heating and cooling.

It is also an object of the present approach to provide a modular LC analysis device in which the capillary LC column is easily loaded and/or replaced when needed.

It is a further object of the present concept to provide a liquid chromatography system employing liquid chromatography capillary column combined with heating elements in a single portable miniature module which is replaceably integratable with a door of a chromatography oven or other heated compartment in order that the LC column module may be easily secured to extend external the oven or heated compartment and wherein free column ends projecting from the LC column module to the injector and detector port inside the oven or heated compartment are heated isothermally.

The present concept includes a temperature programmed low thermal mass fast liquid chromatography (LC) analysis system which includes an LC capillary column having a capillary conduit containing a capillary with stationary phase therein. A heating mechanism which contains a heating insulated wire member is positioned in a conductive heat contact with the capillary separation section along substantially the entire length of the capillary conduit. A temperature sensing unit measures the temperature of the conduit containing the capillary separation section. If the capillary is of sufficient length, the capillary conduit may be coiled.

A temperature control unit is operationally coupled to the heating mechanism to apply a programmed temperature regime (including fast temperature ramps) to the capillary column. A mobile phase injection conduit section is coupled at an inlet end of the capillary separation section to convey a liquid mobile phase from a mobile phase source into the capillary separation section for chromatographic separation therein. A mobile phase outlet conduit section is coupled at an outlet end of the capillary separation section to convey a chromatographically separated liquid mobile phase from the LC capillary column to a chromatographic detection device.

In one embodiment of the subject LC analysis system, a heating insulated wire member, and the temperature sensing unit are combined in a singular assembly that can include additional elements such as a capillary gas chromatography column, to form a plurality of adjacently positioned and axially aligned coiled loops. The coiled capillary separation section of the LC capillary column is placed in axial alignment with the coiled heater and sensor assembly for effective heat transfer therebetween. A sheath formed preferably of a thermally conducting foil material may be applied around the axially aligned heater and sensor assembly and the coiled capillary separation section of the liquid chromatography capillary column.

Alternatively, in its modular miniature implementation, the temperature programmed low thermal mass liquid chromatography analysis system comprises a thin-wall tubing conduit, a short LC capillary column forming a capillary separation section containing a stationary phase therein, a heating insulated wire member positioned in a conductive heat contact with the conduit of the capillary separation section along the entire length thereof, and a temperature sensing unit measuring temperature along the length of the conduit containing the capillary separation section. The LC capillary column is removably received in the tubing and extends therein between the ends of the LC column module.

The heating insulated wire member may be wound around the conduit of the capillary separation section in a helical manner, or may extend adjacent thereto along the entire length thereof within the tubing. The capillary conduit of the LC column, the heating wire, and the temperature sensing mechanism together may form a curved or coiled assembly if the length is sufficient. The tubing is fabricated of an aluminum or steel composition, and is preferably stainless steel capillary tubing if the length is sufficient for coiling.

A mobile phase injection conduit section extends from the capillary separation section at an inlet end thereof to a liquid mobile phase source, thus forming a conduit for conveying the liquid mobile phase from an injector to the inlet of the LC column for chromatographic separation therewithin. A mobile phase outlet conduit section extends between the outer end of the capillary separation section to a chromatographic detection device to convey thereto the liquid mobile phase chromatographically separated in the capillary separation section of the LC capillary column.

The length of the capillary conduit forming the capillary separation section of the LC capillary column may be as short as 0.05 m-2.0 m. Thus the LC column module may be removably received within a housing.

Low thermal mass temperature programmed heaters may be applied to the mobile phase injection conduit section and mobile phase outlet conduit section in proximity to the inlet and outlet ends of the tubing. Such low thermal mass temperature programmed heaters may be implemented as an insulated tube sleeved on a respective end of the tubing. A heater wire is wound on the insulated tube, and an insulated temperature sensing mechanism is coupled to the tube and heater wire. Low thermal mass LC heating conduits for short LC capillary columns such as 20 cm or shorter may be of this same design. A temperature controller unit is operatively coupled both to the heater wire of the LC column and to the heater wire of the low thermal mass temperature programmed heaters. A cooling fan positioned in proximity to the tubing is used for cooling the LC column module.

In order to protect the LC separation column from contamination contained within the incoming mobile liquid phase, a “guard” column (a.k.a. pre-column) may be coupled to the liquid chromatography capillary column upstream thereof. It may also be preferable to arrange an unheated portion of the mobile phase outlet conduit section close to the outlet end of the tubing (either inside or outside the tubing), with a heated portion in proximity, to the chromatographic detection device downstream the unheated portion of the mobile phase outlet conduit section.

The LC column module may be used with a chromatographic oven which includes an oven cavity enveloped by a walled structure in which one wall (or the oven door) has a module receiving opening defined therein. The LC column module may be removably secured to the wall of the oven within the module receiving opening to be disposed external the oven cavity. Another wall of the walled structure enveloping the oven cavity has an injector port and a detector port with injector and detector connectors entering from the injector and detector ports into the oven cavity. The mobile phase injection conduit section and mobile phase outlet conduit section extend in the oven cavity between the LC column module and the injector connector and the detector connector, respectively. The temperature control unit is positioned externally to the oven cavity, while the oven cavity is heated isothermally by a heater positioned within the oven cavity.

Through the combination of a miniature capillary LC column in close contact with the heating wire and temperature sensing mechanism, which are also in axial alignment with the LC capillary column, and the optimal relationship between the elements of the LC analysis system, fast heat exchange therebetween is obtained between them, as well as with the surrounding environment. High throughput analysis rates, as well as a reduced power consumption in the LC analysis system are additionally attained.

These and other features and advantages of the present invention will become apparent after reading a further description of the preferred embodiment in conjunction with the accompanying Patent Drawings.

### BRIEF DESCRIPTION OF THE DRAWINGS

FIG. 1 is a schematic representation of one implementation of the present temperature programmed low thermal mass LC analysis system;

FIG. 2 is a diagram representing three chromatograms showing a comparison of fast temperature programmed LC with other modes of operation of the low thermal mass LC analysis system;

FIG. 3 is a diagram representing the temperature programming performance of the low thermal mass LC analysis system and the speeds of cooling allowed by the system under different conditions;

FIG. 4 is a diagram representing measurements of the instantaneous power consumption by the low thermal mass LC analysis system during its performance of the temperature program illustrated in FIG. 3;

FIG. 5 is a diagram representing a series of chromatograms demonstrating the low thermal mass LC analysis system performing negative temperature programming at different speeds starting from 125° C.;

FIG. 6 is a diagram representing a series of chromatograms demonstrating the low thermal mass LC analysis system performing negative temperature programming at different speeds starting from 125° C. concurrently with elution gradient programming.

FIGS. 7A-7B are schematic representations of a “reloadable” LC system having an LC capillary column, heating wire, and temperature sensor within the tubing (FIG. 7A shows a single loop LC system, FIG. 7B shows schematically a 1.5 loops LC system;

FIGS. 7C-7E show cross-sectional views taken at C-C, D-D and E-E lines, respectively, of the LC system presented in FIG. 7B;

FIG. 8 is a schematic representation of an alternative implementation of the present temperature programmed low thermal mass LC analysis system;

FIG. 9 is a cross-section of the coiled section of the assembly of FIG. 8 taken along lines 9-9;

FIG. 10 is a schematic representation of a portion of the coiled section of the assembly of FIG. 8 taken along the length thereof;

FIGS. 11A-11D are diagrams representing LC analysis chromatograms recorded at different thermal conditions;

FIG. 12 is an expanded view of the separation in FIG. 11A using 30° C./min temperature programming;

FIG. 13 illustrates schematically the concept where the LC column module is incorporated into a door (or a wall) of a chromatographic oven;

FIG. 14 is an exploded view of the present LC module relative to the door of the chromatographic oven;

FIG. 15 is a diagram representing a GC analysis chromatogram used to demonstrate high performance capillary heating by the device shown in FIGS. 7A-7E by substituting a GC capillary column for an LC capillary column;

FIG. 16 is a schematic representation of another alternative embodiment of the subject LC system; and

FIG. 17 is a diagram representing a fast temperature programming of the LC column assembly shown in FIGS. 7A-14.

### DESCRIPTION OF THE PREFERRED EMBODIMENTS

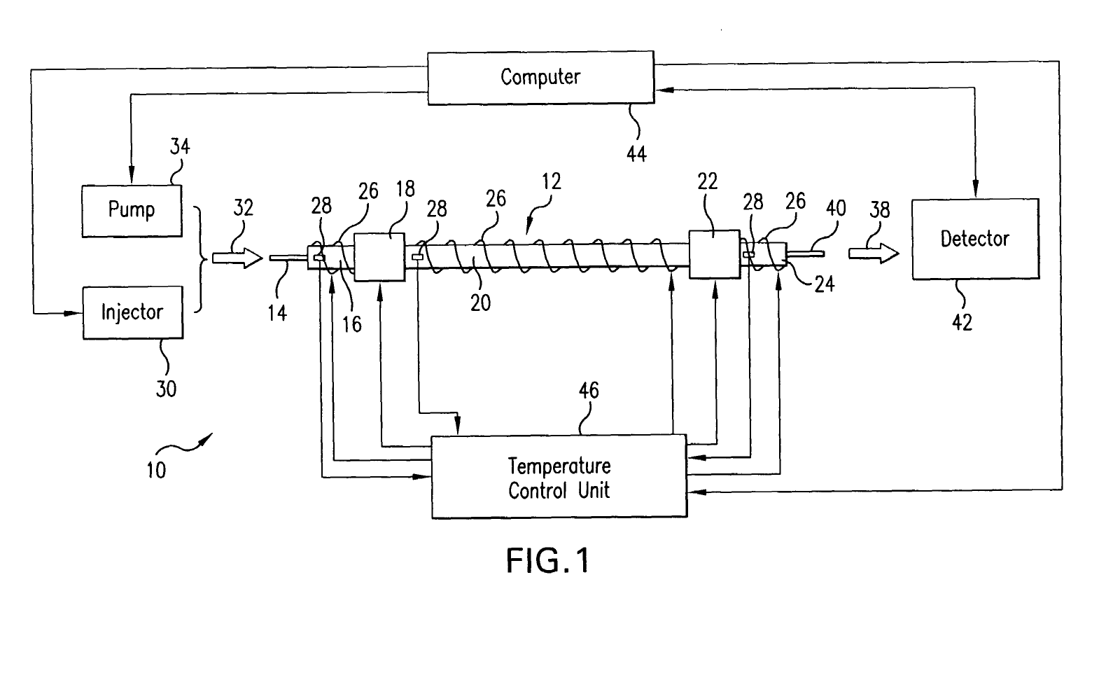

Referring to FIG. 1, there is shown a temperature programmed low thermal mass liquid chromatography analysis system 10 including an LC column 12 having an inlet end coupled to an LC guard column 14 which is a section of a chromatography tubing inserted into a wire heated tube (transfer line) 16 followed by junction 18 to the LC column 12 contained within a wire heated conduit (or tube) 20. The LC column 12 also has an output end coupled to a junction 22 followed by a wire heated tube 24 (an additional transfer line).

The junctions 18 and 22 include chromatography fittings that are heated by a small heating block of material, such as aluminum, with a heating cartridge and temperature sensor. Each tube 16 and 24 is formed of a thin walled metal, such as for example aluminum or stainless steel. Aluminum may be preferred for short lengths tubing because of its high thermal conductivity and its ability to bring heat very effectively to its end edges to avoid cold spots at junctions.

The tubes (or conduits) 16, 20, and 24 are insulated by wrapping with Nextel ceramic fiber roving (3M Corporation, Minneapolis, Minn.) to create a thin, electrically-insulating layer around them. A heater wire 26 is also wrapped with Nextel ceramic fiber roving before winding the heater wire around the tubes 16, 20, and 24.

Small, fused silica-insulated type K thermocouples 28 are made by insulating the 0.005-in. diameter lead wires from each other using 0.010-in. inner diameter fused silica tubing, and then insulating the thermocouple junction and lead wires inside a 0.020-in. inner diameter fused silica tubing. The thermocouples 28 are placed between the heating wire 26 windings and the tubings 16, 20, and 24 near one end so that the thermocouple lead connections may exit away from the windings of the heater wire 26.

An injector 30 is coupled to the guard column (or chromatography tubing) 14. The tube 16 pre-heats the mobile phase before it arrives to the analytical column inside the wire heated conduit 20.

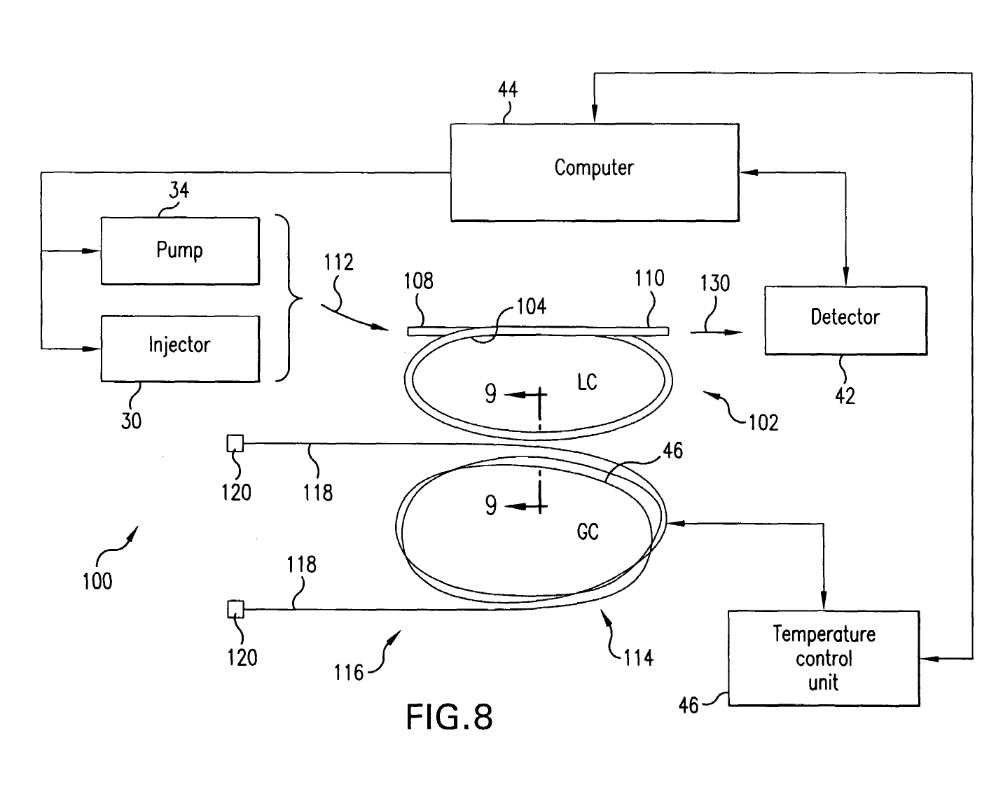

A liquid mobile phase 32, which is a mixture of components to be analyzed, is forced through the LC column 12 inside the tubular heater conduit 20 by a liquid under a predetermined pressure provided by a pump 34. The LC column 12 includes a stationary phase 36 (best shown in FIG. 9). The components in the liquid mobile phase 32 interact with the stationary phase 36 in the LC column 12 to be separated each from the other.

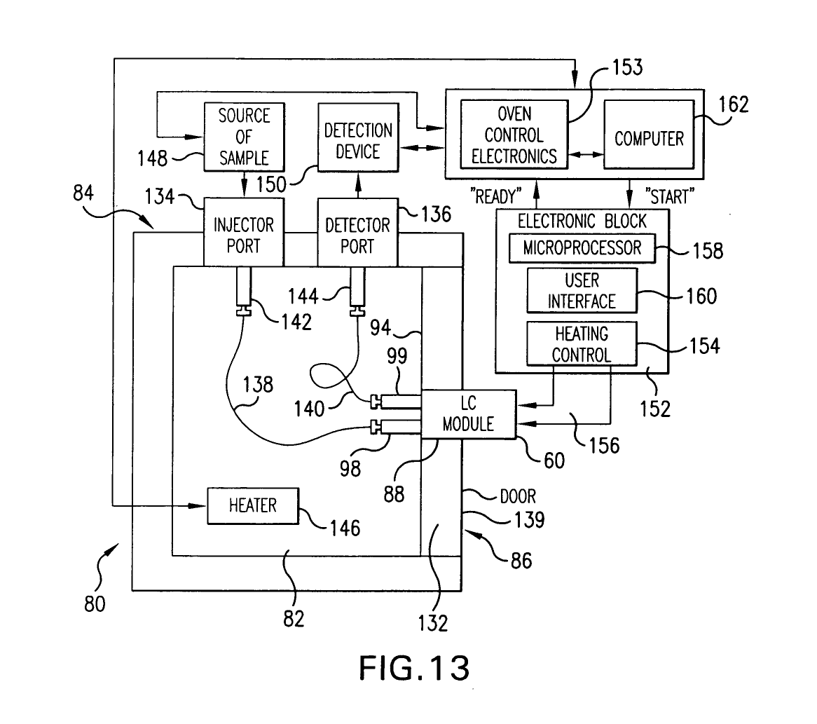

The chromatographically separated liquid mobile phase 38 is conveyed through a mobile phase outlet conduit section 40 (within the tube 24) to a chromatographic detection device 42 for analysis. The mobile phase outlet conduit section is coupled to the LC column 12 at the junction 22. The mobile phase injection conduit section, as well as mobile phase outlet conduit section, are shown in FIG. 13 and may be integral with the capillary of the LC column 12 with either or both of the chromatography junctions 18 and 22 omitted, or may be attached to the capillary LC column 12 in a number of ways well known to those skilled in the art using these junctions.

The chromatographic detection device 42 is coupled to the exit section of the LC column 12 and measures, as well as analyzes, chemicals present in the liquid exiting the LC column 12. A number of commercially available detection devices 42 exist and are not important to the inventive concept as herein described.

A programmable computer 44 is coupled into the system 10 to provide control of the injection device 30, detection device 42, as well as the parameters associated with reduced power consumption LC system 10 including, but not limited to, the temperature programming as well as temperature sensing, reading and adjustment. A temperature control unit 46 contains heater and sensor circuitry for temperature control and programming of the heated zones, and is under control of the computer 44.

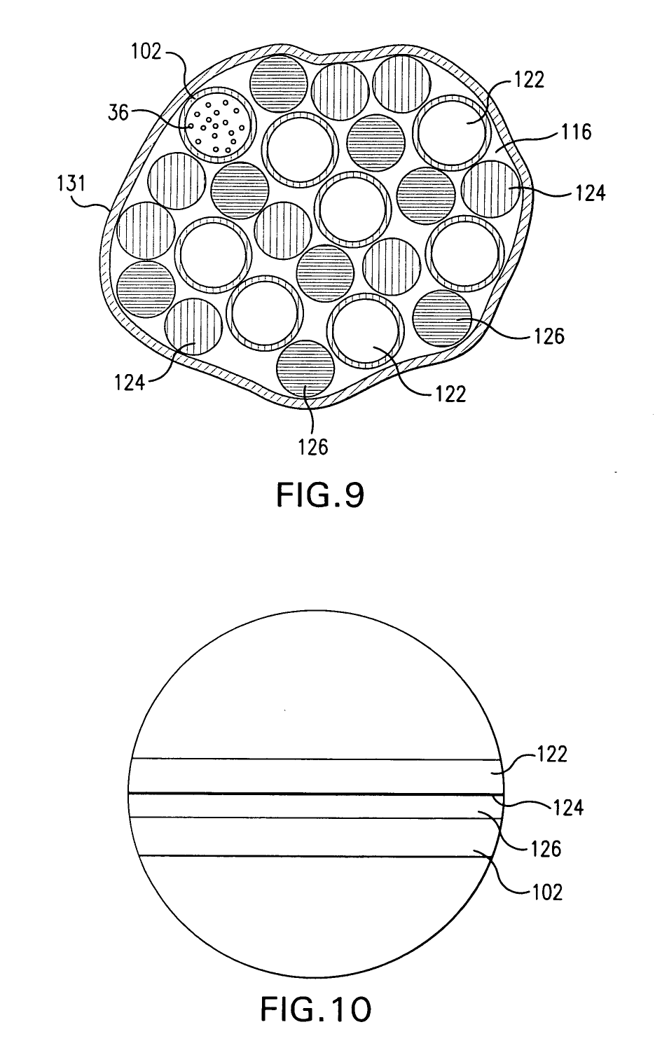

A number of well known temperature sensing mechanisms may be used as long as the particular temperature sensors are of a low thermal mass design. Such temperature sensing mechanisms applicable to reduced power consumption LC systems include resistance temperature devices such as alloys in the form of insulated fine wires which provide for a change in resistance as a function of temperature. Resistant temperature devices generally provide a distributed measurement of the temperature along the entire length of the temperature sensor. It is within the scope of this invention to use also other types of temperature sensing elements providing a more local, aka point measurement of the temperature and such may be in the form of a thermocouple shown in FIG. 1 used in place of the temperature sensor element shown in FIGS. 9 and 10, as will be discussed in further paragraphs.

It is to be understood that the subject LC analysis system 10 is contemplated for use with a number of well known injection devices, detection devices as well as possibly remote computers and monitors. However, computers, injector device, and detection device, as well as the electronics packages associated therewith may assume a variety of circuitry and structural configurations well known in the art which are not germane to the present invention with the exception that they provide proper chemical samples to the LC column 12, as well as appropriate heating and control mechanisms. Thus, for the sake of clarity, further discussion of any electronics packages, computer, detection device, or injection device, will be omitted since they do not form a part of the subject inventive concept.

Additionally, the entrance and exit regions of the LC column assembly 12 are generally heated and maintained at an elevated temperature to prevent stoppage or slowing of analytes through possible cold spots in the LC column system. Such heaters are known in the art and may at times even be included with injection device 30 and detection device 42.

The heater conduit 20 which contains the LC analytical column 12 was made using 0.031-in. inner diameter aluminum tubing having an outer diameter of 0.0625 inch. After wrapping this tubing with Nextel ceramic roving, the tubing 20 was wound with Nextel ceramic roving-wrapped 0.008-inch diameter Stablohm 650 heater wire 26. Temperature control was accomplished using pulse-width modulated control under closed-loop control using the insulated thermocouple 28 and a computer-controlled temperature set point for temperature programming the heater.

The LC analytical column was a 20 cm length of 0.021-in inner diameter fused silica tubing which was packed with 5 micron C18 phase particles taken from a Pinnacle II LC column (Restek Corporation, Bellefonte, Pa.). Theoretical plates were measured at 40° C. and determined to be 80,000 plates/meter for this LC column. The mobile phase was pre-heated with a transfer line heater tube 16 of length 3 inches. A 60 nL injection was done using an AcuRATE passive splitter (Dionex Corporation, Sunnyvale, Calif.) with a split ratio of 100:1. Pump flow was set at 0.4 mL/min. Detection was at 220 nm using a UV detector.

Low thermal mass LC chromatography separations were demonstrated with a mixture consisting of uracil, benzoic acid, 2.4-dichlorophenoxy acetic acid, 4-phenylphenol, ethylbenzoate, benzophenone, naphthalene, and 4-hexylbenzoic acid. The mobile phase was a mixture of the following two phases: A, water/0.1% trifluoroacetic acid; and B, acetonitrile/0.1% trifluoroacetic acid. Isocratic testing was done with a constant mixture consisting of 60% phase B.

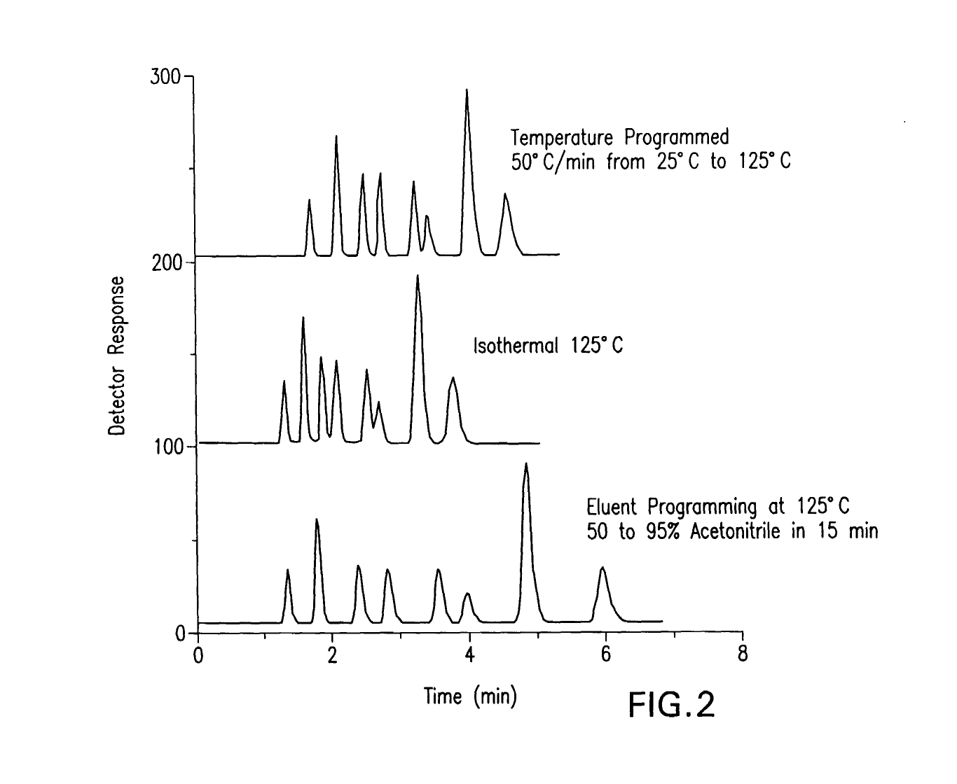

FIG. 2 shows chromatographic separation of this mixture under three different sets of conditions using the low thermal mass LC analytical system. The bottom diagram reflects the separation with the gradient elution separation at 125° C. isothermal control of the LC analytical column. In this example, the eluent mix was programmed from 50 to 95% acetonitrile (phase B) in 15 minutes. This represents a fast elution gradient separation that has been accelerated by the use of high temperature. The middle separation diagrams in FIG. 2 shows the result obtained with elution using 60% B under 125° C. isothermal conditions. The decrease in resolution of the separation may be noted. The top diagram uses the ability of the system to temperature program rapidly at 50° C./min from 25° C. to 125° C. to achieve a fast separation with resolution that is improved relative to the isothermal example at 125° C. without elution gradient separation.

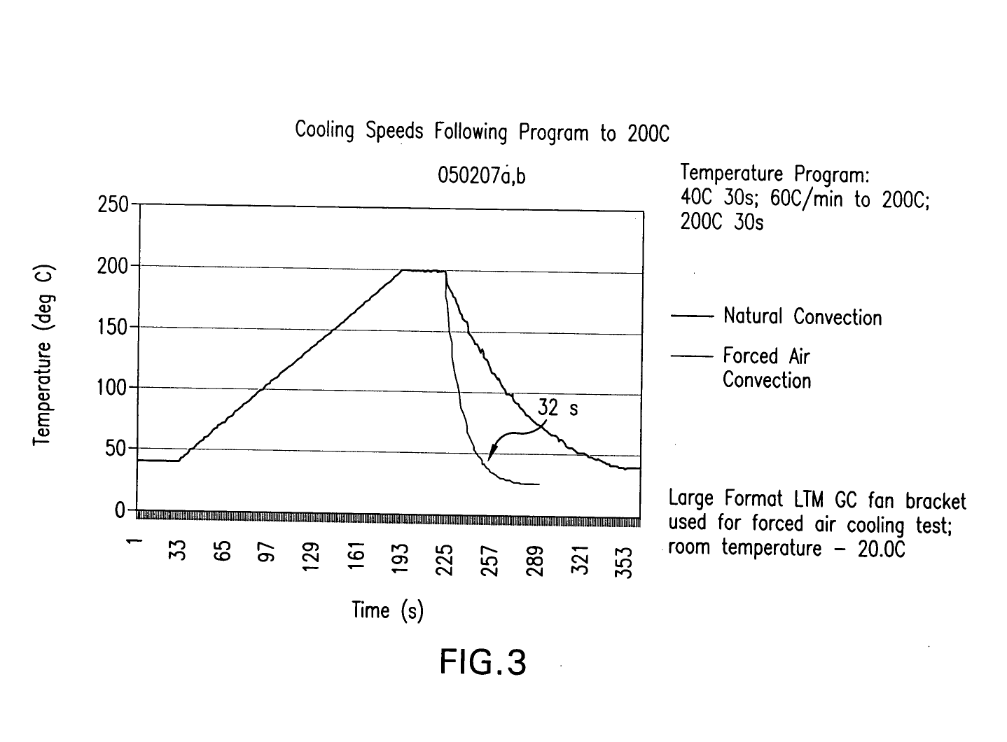

FIG. 3 shows the temperature control of the low thermal mass LC analytical system while temperature programming over an extended temperature range compared to the programming methods used for the separation shown in FIG. 2. In FIG. 3, a superposition of two sets of data is shown recorded from the temperature sensor (thermocouple) 28 attached to the 20 cm aluminum conduit 20 containing the LC analytical column 12. The actual temperature sensor output as measured by the temperature control circuitry was recorded directly to a computer using a Metex M4640-A digital multimeter during the following temperature program: 40° C. isothermal for 30 seconds; temperature program at 60° C./min to 200° C.; and 200° C. isothermal for 30 seconds. The two examples that are superimposed were cooled differently to return to ready conditions for the next analysis cycle; following temperature programming, one example shows the cooling by natural convection in 20° C. laboratory air, while the other applies forced air convection of the same laboratory air using four small 3 inch×3 inch×0.5 inch electric fans contained in a 2×2 array in a bracket. Because of the system's small thermal mass, it can return to 40° C. in 32 seconds using only these small fans. Natural convection requires approximately an additional 100 s to cool to 40° C. These cooling speeds are higher than those obtained with conventional heated zones and small ovens, and make temperature programming feasible for high throughput analysis by greatly shortening the overall analysis cycle time.

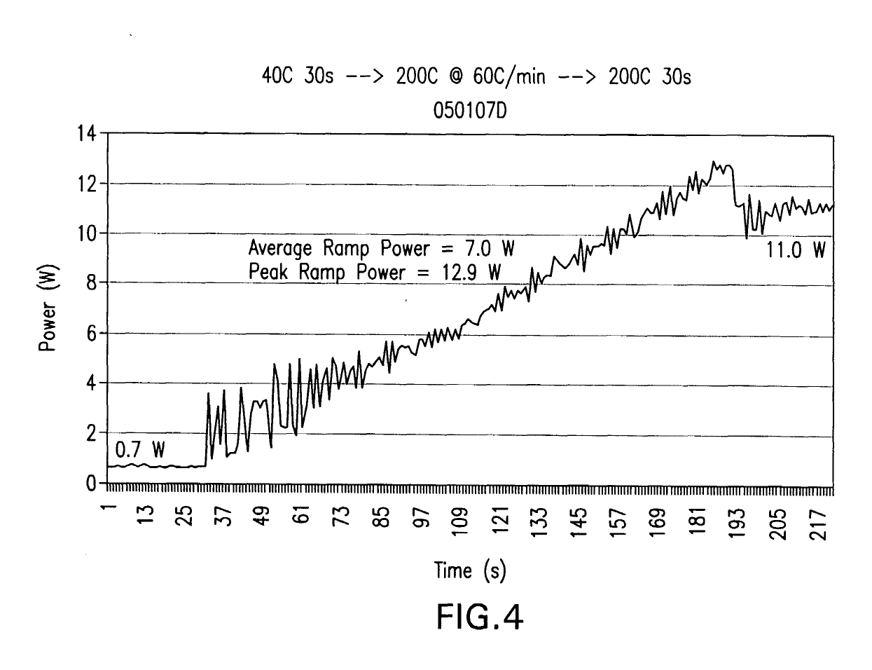

FIG. 4 represents the instantaneous power consumption for the low thermal mass LC analytical system performing the temperature program shown in FIG. 3. The instantaneous heating current was measured with a Metex M-4640-A digital voltmeter and recorded directly to a computer. The instantaneous power was calculated from this current and the voltage used to power the heaters, in this case 48 VDC. The power demands for the isothermal sections of the temperature program at 40° C. and 200° C. are only 0.7 W and 11.0 W, respectively. The average power during the ramp at 60° C./min from 40° C. to 200° C. is 7.0 W. This very low power consumption for temperature programming is a direct result of the low thermal mass of the design.

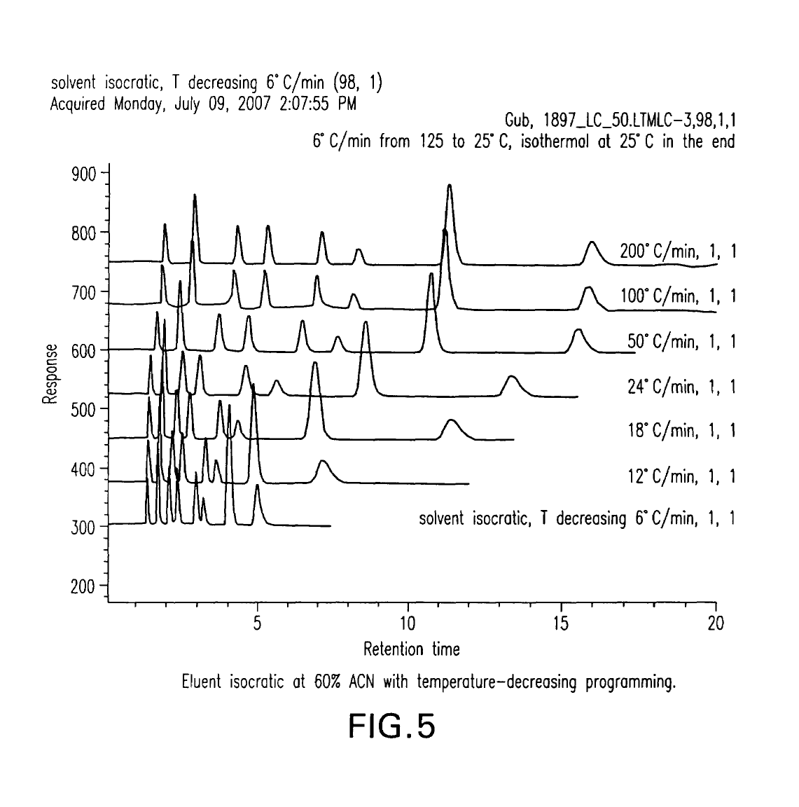

Because the low thermal mass LC analytical system may heat and cool so quickly, it becomes possible to attain the types of temperature programming and analysis not previously possible with LC. FIG. 5 shows the use of rapid negative temperature programming to spread apart the peaks in the analysis of the mixture described above under isocratic elution conditions (60% phase B) starting at 125° C. Negative temperatures programming speeds of up to 200° C./min were possible using the 20 cm length low thermal mass LC analytical system.

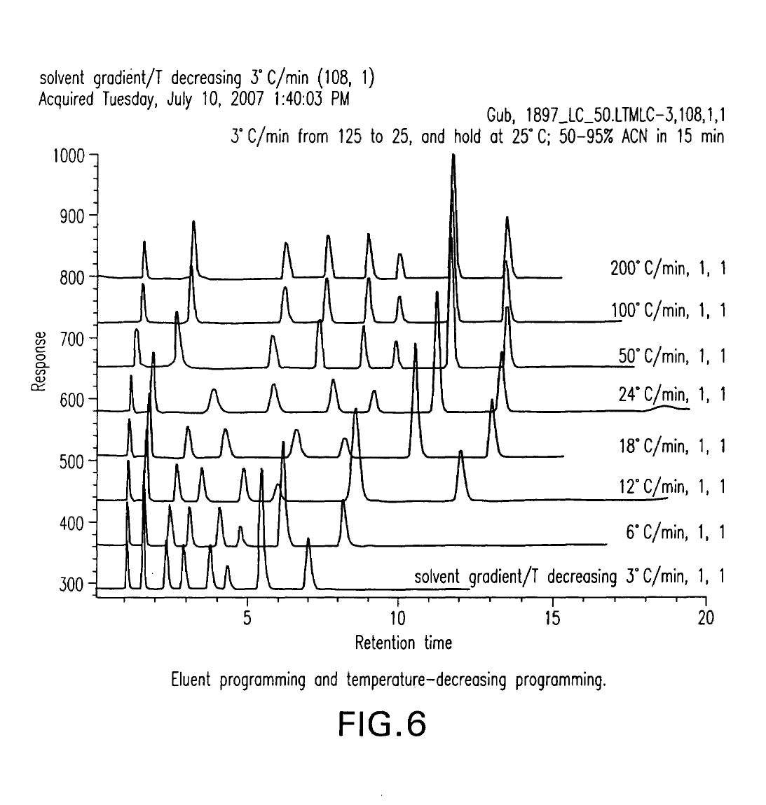

FIG. 6 shows data from a similar study in which eluent programming from 50 to 95% acetonitrile in 15 minutes is being done in addition to negative temperature programming at different speeds from a starting temperature of 125° C. The ability to increase the peak capacity, the number of peaks per unit time that can be resolved, of different regions of the chromatogram can be used to improve resolution when needed. For example, the 4^{th} and 5^{th} peaks in the slowest temperature program in FIG. 5 show some significant overlap. By programming faster these peaks are baseline resolved. Conversely, in the interest of high throughput analyses, the analysis cycle time can be reduced in many cases by adjusting the temperature programs to reduce the peak capacity in regions where it is not needed.

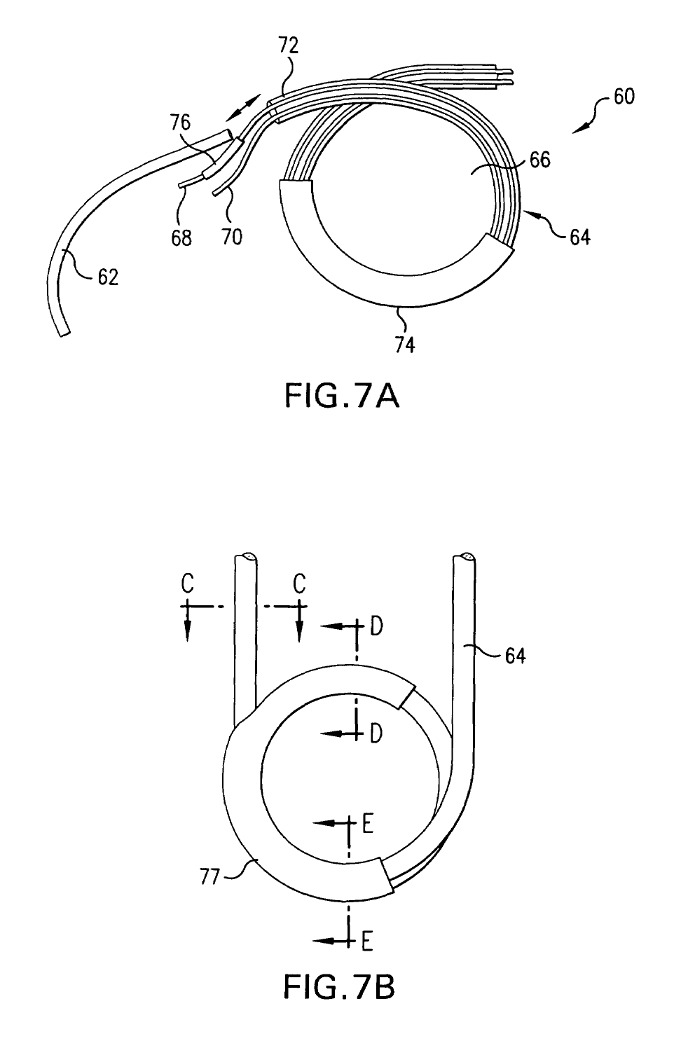

In an alternative embodiment shown in FIGS. 7A-7E, a “reloadable” low thermal mass (RLTM) LC module 60 includes a short capillary LC column 62 removably embedded into a steel tubing 64. This LTM capillary heating module 60 is designed especially for very short columns that facilitates a convenient insertion and exchange of the LC capillary column media. The tubing 64 is a thin-walled stainless steel tubing coiled to form at least one coiled tubing loop 66. The thin-walled stainless steel tubing 64 is first wrapped with Nextel ceramic fiber roving (3M Corporation, Minneapolis, Minn.) to create a thin, electrically-insulating layer 74 around the tubing 64. This is then combined with a temperature sensing component 70 outside and adjacent to insulated tubing 64, as best shown in FIGS. 7A, 7D and 7E. The Temperature sensing component 70 can optionally extend substantially along the length of the insulated tubing 64 to achieve a distributed sensing of the temperature along the length of the insulated tubing 64. The temperature sensing component 70 can optionally spiral along the insulated tubing 64 to accommodate extra component length or facilitate thermal expansion compatibilities. Another layer 75 of Nextel ceramic fiber insulation is wrapped over the tubing 64 and temperature sensing component 70 combination to further electrically insulate the temperature sensing component as best shown in FIG. 7D. Heating wire 68 insulated with a wrapping 76 of Nextel ceramic fiber is then combined with the insulated tubing 64 and sensor 70 combination so that the insulated heating wire 68 lies positionally adjacent. This combination is partially wrapped 79 (as best shown in FIGS. 7D-7E) to bind these components together using Nextel ceramic fiber insulation. This combination is then coiled to create a single loop (as in FIG. 7A) or more loops (as schematically presented in FIG. 7B) of the diameter desired for the module and wrapped with a layer of aluminum foil 77 to conduct heat along the periphery of the device.

Three cross-sectional views of this embodiment 60 shown in FIG. 7B are shown in FIGS. 7C-7D for the case of the loop RLTM LC assembly formed with a one and one-half loop. The entrance and exit leads shown in the cross-sectional view shown in FIG. 7C as taken along lines C-C of FIG. 7B include the thin-walled tubing 64 containing the LC column 12 within. The cross-section shown in FIG. 7D is taken along lines D-D of FIG. 7B through a portion of the assembly containing only a single loop of the components that are bound together with partial wrapping layer 79. The cross-section shown in FIG. 7E is taken along lines E-E of FIG. 7B through a portion of the assembly in which the entrance and exit leads overlap to create the single loop example. This section contains two of the sets of components bound together with the partial wrapping layer 79 as shown in FIG. 7E. The foil outer wrapping 77 is only positioned over the circular loop portion of the RLTM LC assembly. The entrance and exit leads shown in the cross-sectional view of FIG. 7C have bare thin-walled tubing surface with only the LC column 12 contained within and no other components so that both of these leads may be inserted into the tubular heater devices (“transfer lines”) with their own temperature control for interfacing with other components, or integrated directly with other similar devices. The numbering of elements shown in FIGS. 7C-7E correspond to those shown in FIG. 7A.

For testing, the “reloadable” low thermal mass (RLTM)-LC module 60 was fabricated with a stainless steel tubing 64 having the length of 0.7 m, outer diameter of 0.41 mm, and inner diameter of 0.32 mm. A several foot length platinum wire 70 was used for temperature sensing through its resistance change with temperature. The platinum sensing wire 70 had a diameter of 0.002 in. An equal length of nickel alloy 875, wire 68 having a diameter of 0.008 inches and insulated with Nextel roving 76 was used for the heating wire. The entire assembly was shaped into a 5-in. coil having 1.5 loops and electrically interfaced. The assembly, e.g., RLTM-LC module 60, may be used either individually or may be incorporated with a chromatographic oven, such as, for example, a gas chromatography oven.

The concept of the “reloadable” LTM-LC module is applicable exclusively to LC technique and is not believed to be applicable to LTMGC because, unless the LTMGC is made with an extremely short column length for GC, there may be too much friction to force a long capillary GC column through the tubing. Having manufactured thousands of GC column assemblies for fast GC, the shortest length that the present Applicants have commercially manufactured is 2 m. This has been made in small quantities for use with 0.10-mm i.d. column for testing fast GC installations with a highly sensitive mass spectrometer. Longer GC column lengths are more typically used with this application. The maximum length of capillary column which may be forced through slightly larger, smooth-wall metal tubing using the maximum diameter of commercial importance, 5 inches, is approximately 1.3-1.4 m, a value significantly less than the minimum 2-3 m that is considered necessary for commercial GC applications.

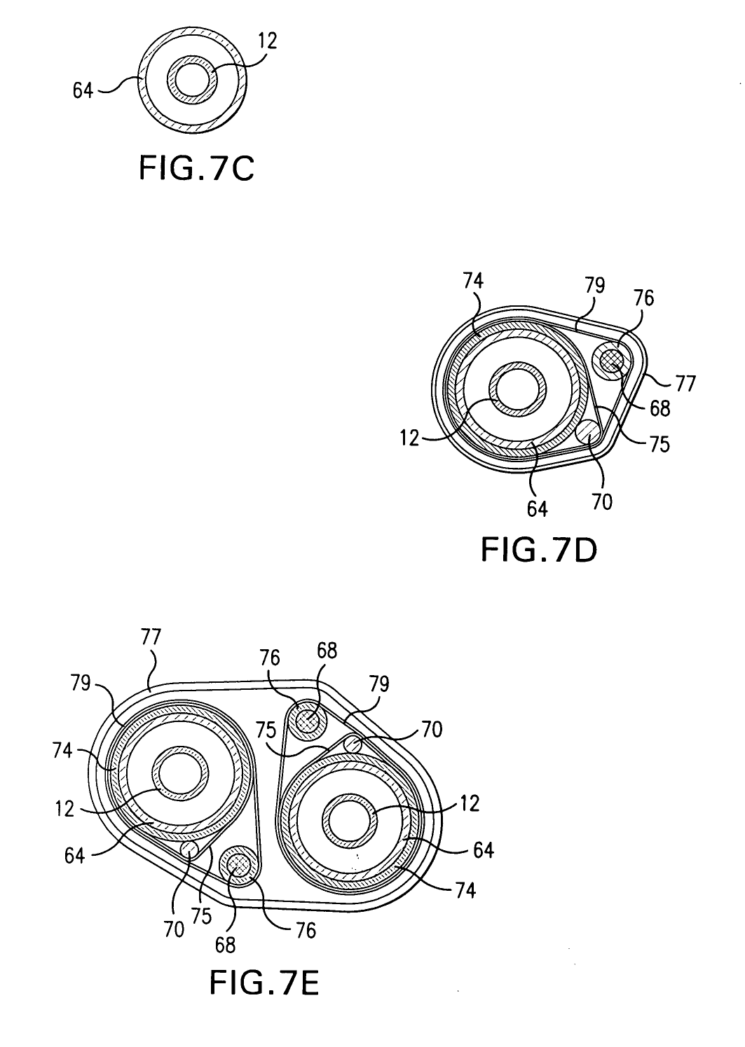

FIG. 8 shows another embodiment of a temperature programmed low thermal mass liquid chromatography analysis system 100 that includes an LC column 102 formed of a short capillary conduit coiled to provide a coiled capillary separation section 104 with a coiled loop in which a stationary phase 36 (shown in FIG. 9) is contained. The LC column 102 has an inlet end 108 and an outlet end 110. The injector device 30 is coupled to the LC column 102 through a mobile phase injection conduit section which extends between the injector device 30 and the inlet end 108 of the LC column 102 to convey thereto a liquid mobile phase 112 for chromatographic separation in the LC column 102. A predetermined pressure of the liquid in the LC column may be provided by a pump 24. At the outlet end 110, the chromatographically separated liquid mobile phase 130 is conveyed to the detector 42 for analysis.

The LC column assembly 102, as presented in FIGS. 8-10 may be heated by means of the heat transfer from a low thermal mass (LTM) GC assembly. For this purpose the LC column is positioned in close heat conducting contact with the coiled section 114 of a gas chromatography (GC) capillary column 116 which also includes lead sections 118. If the GC capillary column 116 is not used for the analysis, the ends of the leads 118 may be capped or closed with seals 120. The coiled section 114, as well as lead sections 118, of the GC capillary column 116 are composed of GC column member 122, temperature sensing mechanism 124, and heating mechanism 126 best shown in FIGS. 9-10. Capillary GC column member 122 has a predetermined length and may be formed of a fused silica or some like material.

The heating mechanism 126 takes the form of an insulated wire member positioned to be adjacent to the capillary GC column member. The heating mechanism 126 is controlled by the temperature control unit 46 which, under the supervision of the computer 44, programmably heats the heating wire 126 to apply temperature gradient (profiles) to the LC capillary column 102.

The temperature sensing mechanism 124 forming a component of the GC column assembly 116 measures the temperature of the stationary phase 36 contained within the capillary LC column member 102. The temperature sensing mechanism 124, extends substantially throughout the predetermined length of, and is located adjacent the capillary LC column member 102, as shown in FIGS. 9-10. As is seen, the temperature sensing mechanism 124 may be located in adjacent positional relationship with the capillary LC column member 102, and may be mounted within the wound coil of the heating wire 126, as shown in FIG. 10.

The LC coiled section 104 of the LC column 102 along with the GC coiled section 114, may be enclosed within an enclosure housing to thermally isolate the LC system assembly from the external environment. Alternatively, as shown in FIG. 9, the entire structure, including the LC column 102 and the GC column assembly 116, may be wrapped into a sheath 131 which may be formed with foil wrappings of the coiled sections 104 and 114.

To test the LC analysis system 100, shown in FIGS. 8-10, a 60 cm×250-μm i.d. fused silica capillary was packed with a stationary phase, including Nucleosil C₁₈ 5 μm particle size slurried in pentane/i-propanol 1:1 (v/v) at a concentration of about 10 wt.-%. Packing was executed with an ISCO syringe pump (model 100 DM) capable of solvent delivery up to 600 bar. A frit was placed at the end of the capillary columns. However for the chromatographic tests no frit has been installed at the inlet.

Demonstration of the fast LC analysis was achieved by modifying the low thermal mass (LTM) GC column module. The capillary LC column 102 was embedded into the low-thermal mass GC assembly 116 so that the coiled capillary separation section 104 of the LC column 102 was axially aligned with the coiled section 114 of the GC column assembly 116. The outer foil of the LTMGC was removed to expose the packed GC column member 122, heater wire 126 and temperature sensor component 124. The LC column 102 was not coiled with heating wire. Instead, it was inserted close to the coiled GC capillary 114. In effect, the LC capillary was in direct contact with the underlying LTM GC assembly for conductive heat transfer to the LC capillary. Less than two turns of the LC capillary is required due to the short LC column length (60 cm). The entire assembly was re-wrapped with the foil sheath which served to conduct heat along the periphery and contain heat within the assembly. The wrapped assembly was connected to the syringe pump, injection device and UV detector.

The mobile phase composition used included acetonirile/water 85/15 (v/v) which was fed into the LC capillary column 102 at a constant pressure of about 300-350 bar. A Shimadzu capillary UV detector (model SPD 6A) was used for analysis detection at 254 nm. Data acquisition was performed using Chemstation™ software, which was run from a 6890 GC (Agilent Technologies) with injection being performed manually. Samples of phthalates were chosen as test compounds for initial evaluations of LTM (low thermal mass)-LC. Di-methyl phthalate, samples of di-butyl phthalate, di-hexyl phthalate and di-octlyl phthalate were received from Sigma Aldrich Co. The entire assembly of the LC column, GC column, heating wire and temperature sensing mechanism wrapped in the foil sheath forms a modular structure.

Separation processes were carried out isothermally at ambient (25° C.) and elevated (40° C.) temperatures. Subsequently, fast thermal gradients were applied in following fashion:

TABLE 1

| Time | |
|---|---|
| (seconds) | Temperature (° C.) |
| 60 | 40 |
| 120 (25° C./min) | 40-90 |
| 400 | 90 |

and

TABLE 2

| Time | |
|---|---|
| (seconds) | Temperature (° C.) |
| 60 | 40 |
| 160 (30° C./min) | 40-150 |
| 400 | 150 |

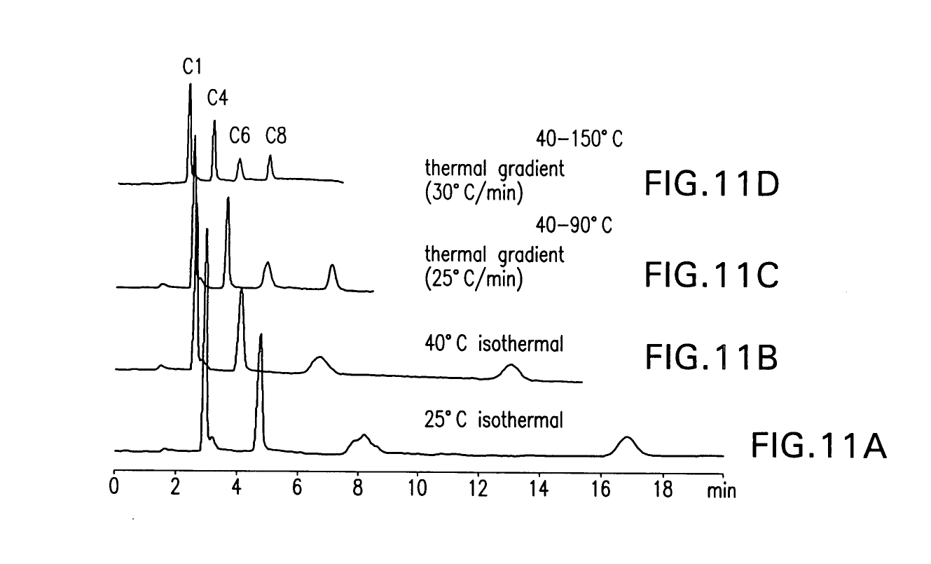

Separations were conducted with a mobile phase composition of acetonitrile/water 85/15 (v/v). Chromatograms presented in FIGS. 11A-11D were recorded at different thermal conditions. Initial separation at ambient temperature (FIG. 11A) and also at 40° C. (FIG. 11B) shows poor separation efficiency for the late eluting hexyl and octyl phthalates, while peak shape for the shorter alkyl phthalates is better.

In the next step, temperature gradients of 25-30° C./min were applied, and final temperatures of 90° C. and 150° C., respectively, were reached. The chromatograms shown in FIGS. 11C-11D show significantly improved peak shape for the last eluting components. As expected, run times were reduced considerably when temperatures of up to 150° C. were reached. Since the LC capillary has not been coiled with the heating wire, the actual temperature in this LC column might be somewhat lower. However, the proof of concept of this embodiment of LTM-LC has been demonstrated.

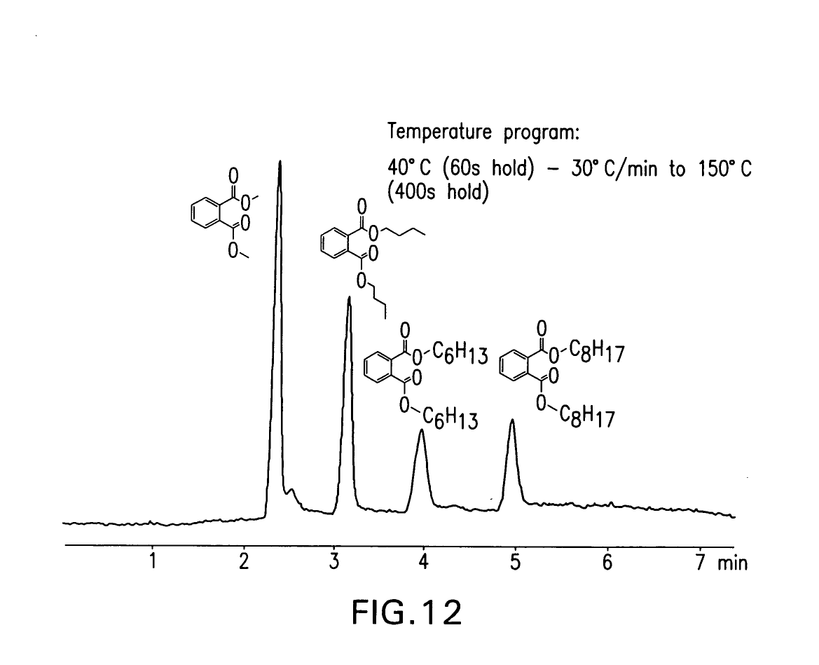

FIG. 12 represents the final separation which was carried out at up to 150° C. Peak shape is sufficient for all components in the separate liquid mobile phases. The baseline is not distorted, despite the high temperature applied. Since no additional cooling steps were introduced after the separation, it is obvious that the capillaries of the flow cell provide sufficient restriction in order to prevent gas formation. A 10 cm path between the LTM-LC module and the UV detector is considered to be sufficient for cooling. The chromatographic system appeared stable during the evaluation period, e.g., no leaks or breaking of the capillary LC column assembly was observed.

Referring to FIG. 13, the present liquid chromatography analysis system comprises an oven or heated compartment. The oven 80 includes an oven cavity 82 surrounded by oven walls 84 and an oven door 86. These are hermetically closed to provide a sufficient thermal insulation between the oven cavity and the external environment. The RLTM-LC module 60 presented in FIGS. 7A-7E, is integratable with any of the walls of the oven, however, it is preferably attached to the oven door 86 for which purpose the door of a conventional liquid chromatography heated compartment or oven is replaced with a door 86 adapted specifically for attaching one or several LTM-LC modules 60.

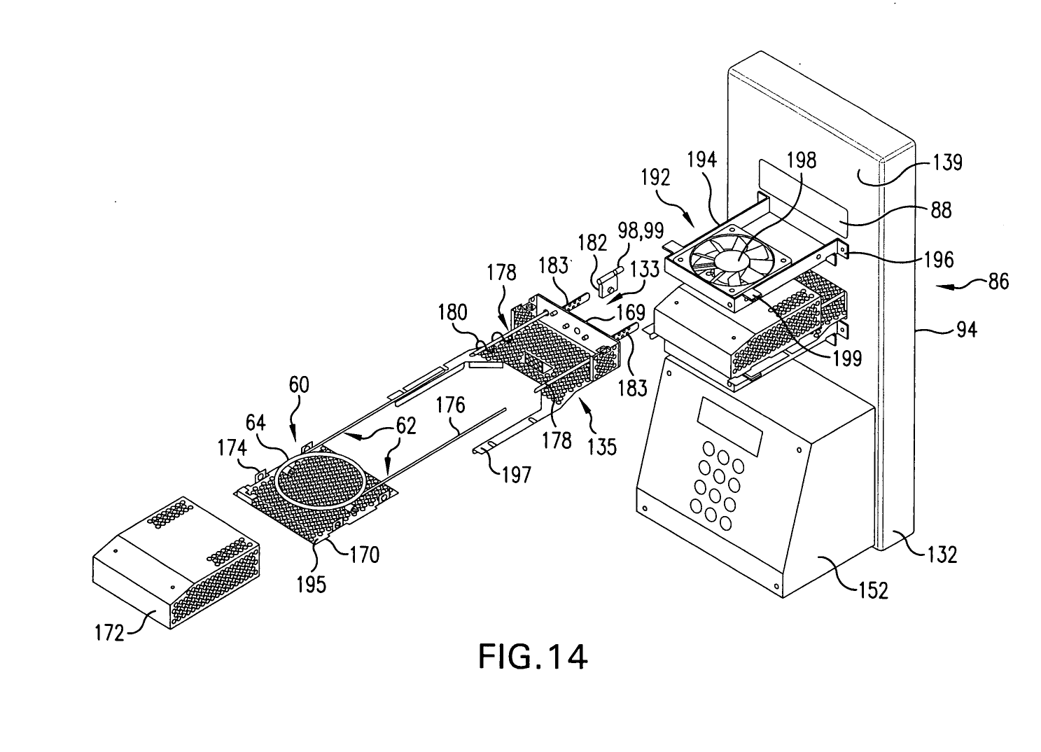

As shown in FIGS. 13 and 14, the door 86 includes module receiving openings 88 formed in the door at predetermined positions. The door 86 is designed to be a replacing element for any conventional chromatography oven or heated zone compartment, for instance, as a replacement door for the Polaratherm™ Series 9000 liquid chromatograph (Selerity Technologies, Inc., Salt Lake City, Utah), as well as others having similar doors. Hinges attach to the left edge on the back side of the door and magnetic latches on the back right side of the door provide for a simple replacement mechanism. The door 86 includes the following elements:

an inner plate 94 contiguous with the oven cavity having feed through holes for the chromatography connections 98, 99 projecting from each RLTM-LC module 60,

an insulation layer 132 having rectangular slots for accommodating the face end 133 of the module 60 therein, and

an outer door 139 having openings 88 positioned in alignment with the slots in the backing plate and the rectangular slots in the layer of insulation 132.

All layers of the oven door 86 are secured each to the other to form a multi-layer structure having high temperature insulation properties. Referring again to FIG. 13, an oven wall 84, which may be any wall of the chromatography oven, but preferably the closest to the oven door 86, has two openings defined therein for providing injector port 134 and detector port 136 of the chromatography system. A pair of capillary column length 138 and 140 which constitute a mobile phase injection conduit section (138) and a mobile phase outlet conduit section (140) extend between chromatography connectors 98 and 99 (extending from the module 60 to the oven cavity) to the injector connector 142 and to a detector connector 144, respectively, which extend into the oven cavity. The column lengths 138, 140 as well as chromatography connectors 98, 99 of the module 60, and injector and detector connectors 142, 144 are exposed to the thermal conditions created within the oven cavity by a heater 146 positioned therewithin.

The injector port 134 is coupled to the source of a sample 148 for injecting the compound to be analyzed into the LC chromatography column 62. A sample injection technique by which a sample is injected into the system from the source of sample may utilize a sample injection technique with a pressurized carrier liquid which the carrier liquid is supplied to the injection port 134 from the source of sample 148 through a valve (not shown) which serves to control the pressure of the carrier liquid in the system. The sample can be considered as being injected using any conventional technique known to those skilled in the art.

The detector port 136 is coupled to the detection device 150. Both the source of sample 148 and the detector 150 are typically coupled to the control electronics 153 of the chromatograph. The injection device 30, detection device 42, the oven control electronics 153, as well as electronics packages associated therewith, may assume a variety of circuits and structural configurations well known in the art. This provides proper chemical samples to the chromatography system.

An electronic block 152 is positioned at the oven door 86 outside the oven. The electronic block contains heating control circuits 154, electrical connections 156 to the module 60, a motherboard with a microprocessor 158, and a user interface 160. The microprocessor 158 and the user interface 160 may be part of the computer 162 positioned within the electronic block 152 or separate therefrom. The electronic block sends and receive signals, e.g., “Ready” or “Start” signals, in communication with the microprocessor controlling the chromatograph or a remote computer controlling the chromatograph, or a related sample injection instrumentation. The electronic block may be integrated with a wall of the chromatography oven such as a door, or be packaged separately from the oven. As shown in FIG. 14, the electronic block 152 may be secured to the lower front of the door 86 to provide a multi-channel control heating of the modules 60 as well as the user interface.

The module 60 may be incorporated into a module housing which includes a module base 170 and a module cover 172, as presented in FIG. 14. The module base 170 may have tabs 174 extending from the edges thereat for securement to the module cover 172 to form the module housing. Alternatively, the tabs may be formed on the module cover 172. The tubing assembly 64 with the LC capillary column 62, as well as heating wire 68 and temperature sensor 70 (shown in FIGS. 7A-7E) are contained in the module housing.

The entering and exiting tubing connections may be heated with miniature low mass heaters (transfer lines) 178 consisting of aluminum tubes wrapped with Nextel fiber insulation and then wound with fiber-insulated heating wire 180. These heaters can be made in different lengths and sleeved over the entering and exiting tubing. For temperature control, an insulated thermocouple is placed between the heater wire windings and the aluminum tube for determining the temperature. Such heaters may be rapidly temperature programmed to heat the mobile phase in these connecting regions to match the temperature of the LC column 62 in the coiled section where the LC capillary extends along with the heating wire and the temperature sensing wire.

As shown in FIG. 14, a pair of wire heated tubes 178 (transfer lines) are sleeved on the ends of the tubing 64. The transfer lines are mounted and supported by a transfer line module base 185. The back face of the transfer line module base 185 attaches directly to the door backing plate 139, the innermost part of the LC retrofit door 86 that becomes a part of the oven chamber wall when the door is closed. A gasket may be used between the transfer line module base and the door backing plate. The transfer lines 178 extend through the insulation of the oven door 86 into the oven cavity. Each tube 178 is formed of a thin walled steel of a relatively low thermal conductivity which is wound with a heater wire 180 controlled by the heating control circuits 154 (shown in FIG. 13). The heater wire 180 is contained within the module housing and terminates near the insulation of back face of the transfer line module base. Wire heated tubes 178 along with the free ends 176 of the capillary column 62 project into the oven and can meet chromatography connectors 98 and 99 (shown in FIG. 13) which extend into the oven cavity. Alternatively, the LC capillary column can extend within the heated zone to reach directly to another component such as a detector or injector if such connectivity is desired.

A transfer line module base 185 has module clamps 182 which may be attached to posts 183 which are positioned at the back face 169 of the transfer line module base 185. Free ends 176 of the LC capillary column 62 emerge from either the tubes 178 or from the tubing 64 within the oven. Connectors 98 and 99 are attached to clamps 182 and receive the free ends 176 of the LC capillary column and hold these in position. The connectors 98 and 99 also receive the mobile phase injection conduit section 138 and mobile phase outlet conduit section 140 (both shown in FIG. 13) and function as unions with small internal dead volume to connect to the LC capillary 62. Alternatively, either or both of the connectors 98 and 99 and clamps 182 may be omitted, and the free ends 176 of the LC capillary column 62 may extend to the connectors at the injector port 142 or detector port 144. The module housing, as well as posts 183 supporting module clamp 182, are fabricated of perforated stainless steel in order to minimize thermal conduction to the interface between the module 60 and the oven cavity 82 for reducing cooling of the oven cavity in proximity to the oven periphery and for reducing heating of module 60 by the oven cavity.

Referring again to FIG. 14, a fan module 192 is positioned in close proximity to each module 60. The fan module 192 comprises a fan bracket 194 which is attached to the oven door 86 by flanges 196 and fasteners (not shown). A cooling fan 198 for accelerated cool down of the module 60 is housed in the fan bracket 194. The transfer line module base 185 has tabs 197 on the underside with slots that engage the two tabs 199 folded outward from the sides of the fan bracket 194. The transfer line module base 185 slides toward the oven where it is attached to the door backing plate from the inside using a captive thumbscrew (not shown). The module housing is supported by the transfer line module base 185. Specifically, tabs 195 extending at the side edges of the module base 170 may be engaged in the tabs 197 of the transfer line module base 185.

For performing a test of the heating reproducibility of the subject LC module, a short piece of 0.12 micron thickness capillary column of approximately 1 m in length was inserted in the tubing. While such a length is unusually short for a GC capillary column, it is possible to do some fast chromatography with a compound mixture having a strongly temperature-dependent separation to measure the thermal performance. The reloadable LTM-LC assembly (RLTM-LC) was attached to the door of the HP5890GC so that the two ends of the steel tubing 64 were inserted through the interface into the oven interior. In this case the tubing 64 was a Varian CP-Sil 5 CB with an internal diameter of 0.10-mm. The capillary was connected at one end to the sample injector port in the HP 5890 oven, while the other end was connected to the inlet of a flame ionization detector.

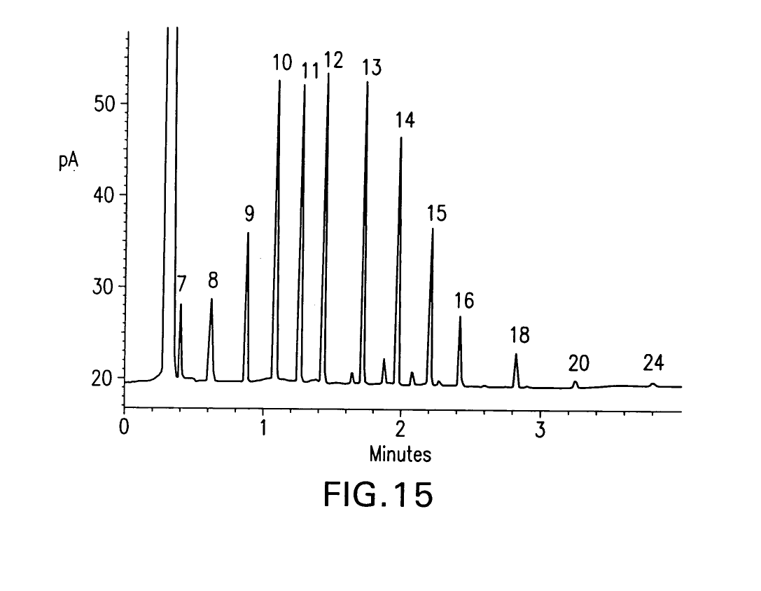

To demonstrate fast chromatography of the “reloadable” capillary within the tubing of the RLTMLC device, a test mixture of hydrocarbons in the range of C7 to C24 was injected with a 10:1 split. A temperature program of 40° C.—30 seconds—100° C./min-300° C.—60 seconds was used. The resulting chromatogram is shown in FIG. 15. The chromatogram appears normal in all respects including good peak shapes and the expected relative peak heights. After overnight heating at a constant 280° C., there was no visual signs of darkening or overheating of the polyimide coating. The analysis of a set of 11 replicate runs with a different test mix and a 0.1 mm×0.2 micron CB-Wax 52 CB column showed that relative standard deviations were typically less than 0.5% in retention time and approximately 0.5% in area.

The RLTM-LC assembly was observed to cool from 300° C. to 40° C. in less than 30 seconds. This cooling was effected by four small electronic fans using ambient room air to cool the assembly. These fans are a normal part of the replacement door product for the HP 5890 that was used in this test. The cooling was considerably faster than the cooling of the transfer line tubes 178 in the interface to the oven using the same forced convection cooling fans in the test setup with the HP 5890 GC. This fast cooling demonstrates the rapid rate of heat loss (>8° C./s) that is possible with the subject system.

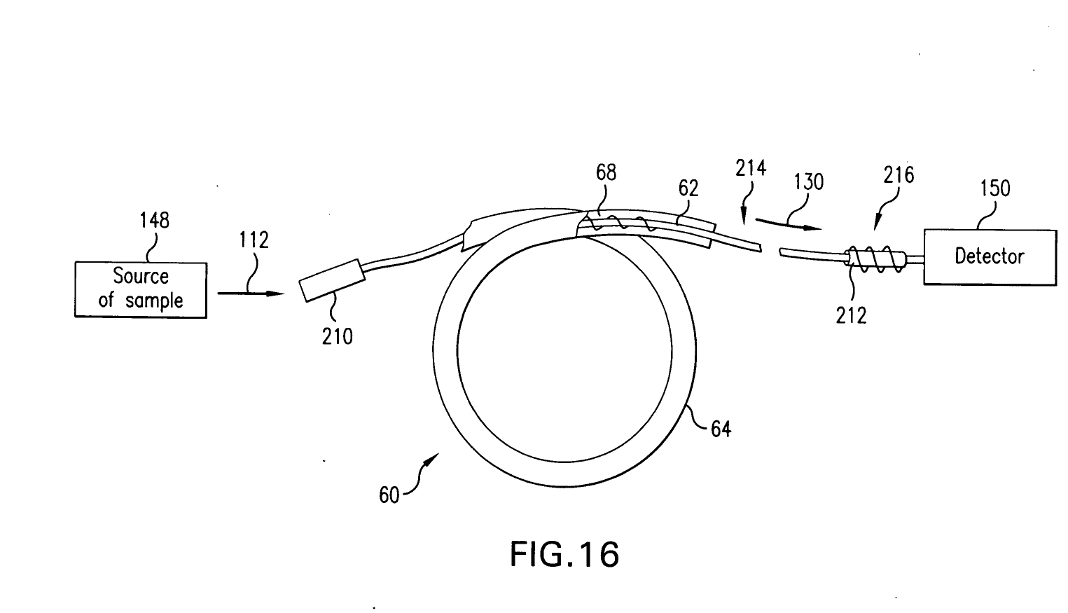

It is often desirable to protect the analytical column with an easily replaceable “phaseless” pre-column (a.k.a. “guard column”) to prevent contamination that may be present at low levels in samples from reaching the analytical column. The pre-column 210, schematically shown in FIG. 16, is positioned upstream the capillary separation LC column 62. The pre-columns for LC chromatography are known to those skilled in the art, and are not discussed herein in detail. The pre-column 210, can also be used as a region to heat the mobile phase to a temperature to match the analytical column.

It also may be desirable to leave a portion of the LC capillary column free of the heating wire either inside or beyond the steel tubing 64 to allow rapid heat loss and cooling before reaching the detector. Since temperature fluctuations at the detector may result in detector noise, drift, or instability, an important approach in conjunction with fast temperature programming may be to have a gap in the heating near the tubing exit for the purpose of cooling, followed by a small heater 212, shown in FIG. 16 to bring the temperature back to a constant value before the detector connection. In this manner there is an unheated zone 214 of the LC column at the outlet thereof and a heated zone 216 downstream the heated zone 214.

Additional testing for power consumption was performed on the RLTM-LC module which used a 28 cm×0.43-mm i.d.×0.51-mm o.d. steel tubing. This length is more suited to a capillary LC application than the tubing 0.7 m-1m length used in the previous test to explore the temperature uniformity and heating speed. For compactness, the 28 cm length of tubing was shaped into a 3.5-in. coil and placed over a single small fan for cooling.

The RLTM-LC module 60 shown in FIGS. 7A-7E was combined with two of the smaller (1.5-in. length) transfer lines placed on the entering and exiting tubing ends for measuring the power consumption and temperature programming performance of the module 60. The current required for pulse-width modulated heating of the three heated zones (two transfer lines and the separation LC column) from a 48 VDC power supply to control the zones to a programmed temperature set-point was measured using a Metex M-4640A digital multimeter and recorded directly to a computer using the Metex software. The digital multimeter was also used to record the actual temperature sensor readings during the temperature program to monitor the correspondence to the expected temperature program. The temperature program was 30° C.—10 seconds—various programming rates—250° C.-10 seconds. Recording was continued during the cooling process after the program to show the rapid cooling of the RLTM-LC module.

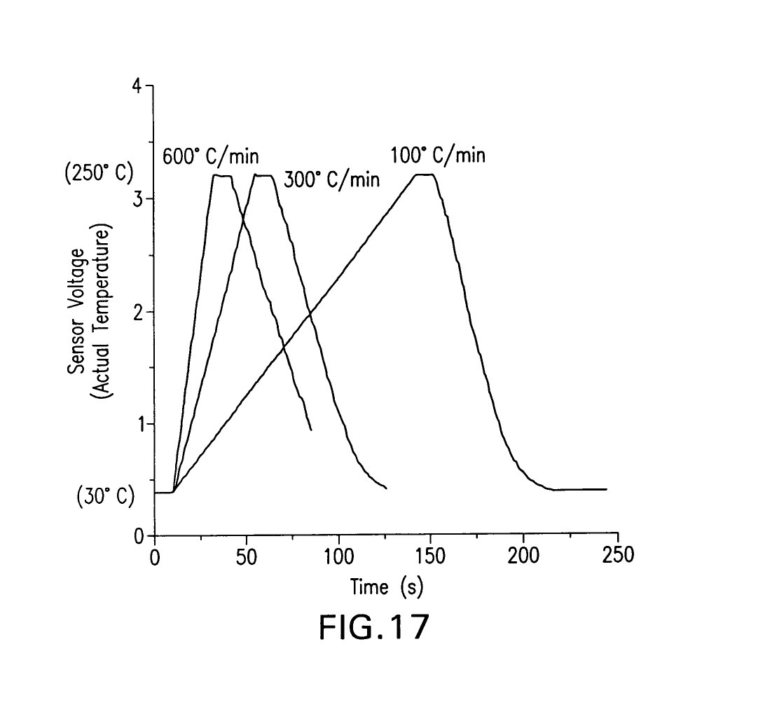

The diagrams of the actual sensor outputs during temperature programming at programming rates of 100° C./min, 300° C./min, and 600° C./min are shown in FIG. 17. The sensor voltage scale is linear in temperature with 0.40 V corresponding to 30° C. and with 3.21 V corresponding to 250° C. The temperature program was computer generated and corresponding temperature set points were created by the computer using a digital-to-analog converter. These set points then went to a heating controller board in control of the three heated zones. The mT-TC4 heating controller board from RVM Scientific, Inc. (Santa Barbara, Calif.) was used for this purpose. This heating controller board provides an analog output for the temperature sensing circuits for each of the three heated zones. This signal for the separation section of the RLTM-LC was directly recorded with the digital multimeter/computer to acquire the data presented in FIG. 17. The signal ramps appear substantially linear, and because of the very low thermal mass of the system and its inherent ability to cool, there is no significant overshoot of temperature at the end of the ramps. The tested system cooled from 250° C. to 50° C. in 45 seconds, with a rate of approximately 4.4° C./s. The cooling rate was still quite fast down to 30° C.

The power consumption for the RLTMLC assembly was very small, even with such large ramping rates and high temperatures. The total power required for 30° C. isothermal operation of all three heated zones at the beginning of the program was 0.9 W. For the 250° C. isothermal operation, the final segment of the program, the power required for all three zones was approximately 20 W. The power required during the linear ramp is equal to the power that would be required for isothermal operation at the intermediate temperature plus the power required to change the temperature. This additional power required for the temperature change is proportional to the mass of the system and the rate of temperature change. The peak power required at the height of the ramping (the moment the highest temperature is attained), and the average power required during the ramping segment are shown in the Table 3.

TABLE 3
Power Requirements for RLTMLC Ramping from 30° C. to 250° C.
with Two 1.5-in Transfer Lines

| Ramping Rate (° C./min) | Average Power (W) | Peak Power (W) |
|---|---|---|
| 100 | 12 | 21 |
| 300 | 19 | 30 |
| 600 | 31 | 40 |

These results show that the power requirements are relatively small for the RLTM-LC module and that it may be easily operated with batteries for applications requiring low power such as transportable or portable systems.

The following areas benefit strongly from successful application of low thermal mass LC system presented in the subject Patent Application:

1. Fast capillary LC: application of fast thermal gradients allow significant speed gains to be captured with a miniaturized system. Such speeds of temperature increase and decrease are not possible with other LC approaches because of their large thermal masses. With high temperatures, no ultra-high pressure capability is required which would allow fast and high-resolution chromatography to be carried out with conventional capillary LC instrumentation. Application of high temperatures enable utilization of solvents which are not practical at low temperatures, such as water or ethylene glycol. Further, this is a powerful second dimension for two-dimensional liquid chromatography (2D-LC), where two analytical columns are arranged in series so that the eluent of the first column can be directed to the second column, typically in a “gated” manner. The first column is usually a high resolution column, and injection of a collected sample from the first column into the second column can create further separation, especially by using different separation characteristics for the second analytical column. If multiple samplings from the first column are to be analyzed during the analysis on the first column, then a second column is typically selected and optimized for fast separations using a different packing chemistry to further the separation. The ability to perform the fast LC is useful for these higher resolution, multi-dimensional approaches. In the extreme, there are techniques referred to as “comprehensive” multi-dimensional chromatography in which all of the eluent from the first column is collected and periodically injected into the second column using a “modulator” device connecting the two columns. Comprehensive techniques require a fast separation by the second column.

2. The subject technique is beneficial in micro-size exclusion chromatography (micro-SEC), as minimal amounts of solvents would be required. This is particular powerful for high-temperature SEC (HT-SEC) of polyolefins, for which trichlorobenzene (TCB) solvent use would be significantly reduced. HT-SEC systems may be miniaturized and the technology leveraged in many laboratories. Size exclusion chromatography is a liquid-based chromatography in which the packing material primarily interacts with solutes in the eluent by having pores of a certain size range which allow molecules of certain dimensions to enter by diffusion in the mobile phase. The time “lost” by molecules diffusing into and out of these pores compared to molecules which are too large to enter the pores then forms the basis for separation. In this process the molecules which are too large to enter the pores are not retarded by this process and elute faster than the smaller molecules which must diffuse back out of the pores to continue their elution progress.

3. Temperature gradient interaction chromatography (TGIC): better separations with regard to small molecule, oligomer or polymer/copolymer analysis may be attained. The subject LTM-LC approach enables new kinds of TGIC, considering very fast thermal gradients or even reverse thermal gradients. Combinations of mobile phase gradient, e.g., the variation in a blend of solvents, and fast temperature ramps facilitate separation of complex mixtures or allow easier determination of specific components in a complex mixture.

4. High-speed temperature rising elution fractionation (TREF). Conventional runs take up to several hours per sample, while the subject LTM-LC technique provides run times of several minutes. This is an important tool for high-throughput fractionation of polyolefins. TREF is a standard approach for the analysis of polyolefins such as polyethylene and polypropylene. In this process, samples are crystallized in a solvent and then eluted under a rising temperature program. The soluble fractions are allowed to elute first, and then the rising temperature program elutes successively higher melting point fractions of the polyolefins. Typically, a low density fraction will elute first, followed by a high density (higher melting point) fraction. The polymer densities are determined by the structure of the polyolefins such as degree of branching, side chain lengths, etc.

Although this invention has been described in connection with specific forms and embodiments thereof, it will be appreciated that various modifications other than those discussed above may be resorted to without departing from the spirit or scope of the invention as defined in the appended claims. For example, equivalent elements may be substituted for those specifically shown and described, certain features may be used independently of other features, and in certain cases, particular applications of elements may be reversed or interposed, all without departing from the spirit or scope of the invention as defined in the claims.

What is claimed is:

1. A temperature programmed low thermal mass liquid chromatography (LC) analysis system, comprising:
at least one LC column module having an inlet end operatively coupled to a mobile phase source and an outlet end operatively coupled to a chromatographic detection device, said at least one LC column module including:
(a) a tubular heater member having a first end and a second end;
(b) an LC capillary column including a capillary conduit forming a capillary separation section containing a stationary phase therein, said LC capillary column extending within said tubular heater member substantially along the entire length thereof;
(c) a heating insulated wire member positioned in conductive heat contact with said tubular heater member substantially along the entire length thereof;
(d) a temperature sensing unit measuring a temperature along said capillary separation section; and
(e) a temperature control unit operationally coupled to said heating insulated wire member of said at least one LC column module to apply a programmed temperature regime thereto.

2. The temperature programmed low thermal mass LC analysis system of claim 1, further comprising:
a mobile phase injection conduit section coupled to said capillary separation section and extending between said first end of said tubular heater member and said mobile phase source to convey therefrom a liquid mobile phase into said capillary separation section of said LC capillary column,
a mobile phase outlet conduit section coupled to said capillary separation section and extending between said second end of said tubular heater member and said chromatographic detection device to convey thereto the liquid mobile phase chromatographically separated in said capillary separation section of said LC capillary column,
a pair of low thermal mass temperature programmed heaters, each coupled to a respective one of said mobile phase injection conduit section and mobile phase outlet conduit section in proximity to said first and second ends of said tubular heater member, respectively,
each of said low thermal mass temperature programmed heaters including:
an insulated tube sleeved on the respective one of said mobile phase injection conduit section and mobile phase outlet conduit section,
a heater wire wound on said insulated tube, and
an insulated temperature sensing mechanism coupled to said heater wire, said heater wire being connected to said temperature control unit.

3. The temperature programmed low thermal mass LC analysis system of claim 1, wherein said tubular heater member is a straight tubular heater member, and wherein said heating insulated wire is wound on said straight tubular heater member.

4. The temperature programmed low thermal mass LC analysis system of claim 1, wherein said capillary conduit is a coiled capillary separation section of said LC capillary column having at least one coiled LC capillary loop.

5. The temperature programmed low thermal mass LC analysis system of claim 1, wherein said LC capillary column is a capillary conduit having a length in the range of 0.05 m-2.0 m.

6. The temperature programmed low thermal mass LC analysis system of claim 1, further comprising an electrically-insulating layer encapsulating said tubular heater member.

7. The temperature programmed low thermal mass LC analysis system of claim 1, further comprising a guard column coupled to said liquid chromatography capillary column at said first end of said tubular heater member for contamination prevention.

8. The temperature programmed low thermal mass LC analysis system of claim 2, wherein said mobile phase outlet conduit section extending substantially between said second end of said tubular heater member and said chromatographic detection device includes a heated portion in proximity to said chromatographic detection device and an unheated portion upstream of said heated portion.

9. A temperature programmed low thermal mass liquid chromatography (LC) analysis system comprising:
(a) a liquid chromatography (LC) capillary column including a capillary conduit coiled to form a coiled capillary separation section having at least a single coiled loop containing a stationary phase therein,
(b) a mobile phase injection conduit section coupled at an inlet end of said coiled capillary separation section, said mobile phase injection conduit section conveying a liquid mobile phase from a mobile phase source into said coiled capillary separation section for chromatographic separation therein,
1(c) a mobile phase outlet conduit section coupled at an outlet end of said coiled capillary separation section, said mobile phase outlet conduit section conveying a chromatographically separated said liquid mobile phase from said LC capillary column to a chromatographic detection device,
(d) a heating mechanism containing a heating insulated wire member wound to form at least one heating loop positioned in a conductive heat contact with said coiled capillary separation section along substantially the entire length of said capillary conduit thereof,
(e) a temperature sensing unit measuring a temperature along said capillary conduit of said coiled capillary separation section, and
(f) a temperature control unit operationally coupled to said heating mechanism to apply a programmed temperature regime to said LC capillary column.

10. The temperature programmed low thermal mass LC analysis system of claim 9, further comprising a capillary gas chromatography (GC) column member having a plurality of adjacently positioned coiled loops forming a coiled section of said capillary GC column member, wherein said heating insulated wire member and said temperature sensing unit are located adjacent to said plurality of coiled loops of said coiled section of said capillary GC column, said capillary GC column, temperature sensing unit, and heating mechanism forming a GC column assembly having a respective length defined by the summation of the lengths of each of said plurality of the coiled capillary loops, and further having a cross-section defined by a combined cross-section of said plurality of the coiled loops, said temperature sensing unit, and said heating mechanism.

11. The temperature programmed low thermal mass LC analysis system of claim 10, wherein said coiled capillary separation section of said LC capillary column is positioned in axially aligned relationship with said coiled section of said capillary GC column member.

12. The temperature programmed low thermal mass LC analysis system of claim 11, further including a sheath formed around said axially aligned coiled section of said GC column member and said coiled capillary separation section of said LC capillary column, said sheath being formed of a thermally conducting foil material.

13. The temperature programmed low thermal mass LC analysis system of claim 10, wherein said temperature sensing unit is located in axially aligned relationship with said capillary GC column member.

14. The temperature programmed low thermal mass LC analysis system of claim 9, wherein said temperature sensing unit includes a mechanism for distributed temperature measurement throughout at least a portion of a length of said temperature sensing unit.

15. The temperature programmed low thermal mass LC analysis system of claim 9, further comprising an LC column module including a tubing having a first end and a second end, said LC capillary column, being removably received within said tubing, and extending therein between said first and second ends thereof adjacent each to the other, said tubing being coiled to form at least one coiled tubing loop.

16. The temperature programmed low thermal mass LC analysis system of claim 9, wherein said insulated wire member is formed of an alloy of chromium and nickel.

17. The temperature programmed low thermal mass LC analysis system of claim 9, wherein said temperature sensing unit is a resistance thermal device.

18. The temperature programmed low thermal mass LC analysis system of claim 15, further comprising:
an oven including an oven cavity enveloped by a walled structure having at least first and second walls thereof, said first wall having at least one module receiving opening defined therein, said second wall having an injector port and a detector port defined therein, and injector and detector connectors entering from said injector and detector ports, respectively, into said oven cavity, and
at least one said LC column module removably secured within said at least one module receiving opening formed in said first wall and disposed externally of said oven cavity;
wherein said mobile phase injection conduit section and said mobile phase outlet conduit section extend in said oven cavity between said at least one LC column module and said injector connector and said detector connector, respectively, and
wherein said temperature control unit is positioned external said oven cavity.

19. A temperature-programmed low thermal mass liquid chromatography (LC) analysis system, comprising:
(a) at least one LC column module having an inlet end operatively coupled to a mobile phase source and an, outlet end operatively coupled to a chromatographic detection device, said at least one LC column module including:
a tubing having a first end and a second end, said tubing being coiled to form at least one coiled tubing loop,
an LC capillary column including a capillary conduit forming a capillary separation section containing a stationary phase therein,
a heating insulated wire member positioned in a conductive heat contact with said capillary conduit of said capillary separation section substantially along the entire length thereof, and
a temperature sensing unit measuring a temperature along said substantially the entire length of said capillary separation section,
wherein said LC capillary column, heating insulated wire member, and temperature sensing unit are removably received within said tubing to extend therein adjacent each to the other along said at least one coiled tubing loop between said first and second ends of said LC column module;
(b) an oven including an oven cavity enveloped by a walled structure having at least first and second walls thereof, said first wall having at least one module receiving opening defined therein, said second wall having an injector port and a detector port defined therein, and injector and detector connectors entering from said injector and detector ports, respectively, into said oven cavity, said at least one LC column module being removably secured within said at least one module receiving opening formed in said first wall and disposed externally of said oven cavity; and
(c) a temperature control unit positioned external to said oven cavity and operationally coupled to said heating insulated wire member to apply a programmed temperature regime thereto.

20. The temperature programmed low thermal mass LC analysis system of claim 19, further comprising:
a mobile phase injection conduit section coupled to said capillary separation section and entering between said first end of said tubing and said mobile phase source to convey therefrom a liquid mobile phase into said capillary separation section of said LC capillary column; and
a mobile phase outlet conduit section coupled to said capillary separation section and extending between said second end of said tubing and said chromatographic detection device to convey thereto the liquid mobile phase chromatographically separated in said capillary separation section of said LC capillary column;
wherein said mobile phase injection conduit section and said mobile phase outlet conduit section extend in said oven cavity between said at least one LC column module and said injector connector and said detector connector, respectively.
